(19) United States
(12) Patent Application Publication
(10) Pub. No.: US 2007/0217712 A1
(43) Pub. Date: Sep. 20, 2007

(54) METHOD AND APPARATUS FOR SCALING IMAGE DATA

(76) Inventors: Sen-Huang Tang, I-Lan Hsien (TW); Chia-Wei Yu, Taipei City (TW); Chi-Feng Wang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/684,649

(22) Filed: Mar. 12, 2007

(30) Foreign Application Priority Data
Mar. 16, 2006 (TW) 095109045

(51) Int. Cl. G06K 9/32

(52) U.S. Cl. 382/298

(57) ABSTRACT

An apparatus and a method for processing image data are disclosed. The apparatus detects whether the image data corresponds to one of a plurality of predetermined patterns to generate a detection result, selects one of a plurality of processing algorithms according to the detection result, and processes the image data according to the selected processing algorithm.

### BACKGROUND OF THE INVENTION

1. Field of the Invention

The present invention relates to an image processing apparatus, but more particularly relates to an image scaling apparatus.

2. Description of the Prior Art

The conventional image scaling method usually utilizes an interpolation method. For example, a user personally adjusts the size of a display window in a windows operational environment. Also, the prior art image processing method usually utilizes a filter to perform an interpolation method, but this results in a non-ideal image quality. If the filter characteristic is too smooth, then the obtained image will be too blurry for identification. However, if characteristic of the filter is too sharp, then the obtained image will also be too sharp and will have non-continuous hues. Additionally, sawtooth edges and mosaic grids may occur in the oblique lines of the image using the two-dimensional interpolation method. That is, the conventional scaling method reduces the image quality substantially.

### SUMMARY OF THE INVENTION

Therefore, one of objectives of the present invention is to provide a method and an apparatus to solve the above-mentioned problems.

Therefore, one of objectives of the present invention is to provide a scaling method and a scaling apparatus which provides a plurality of scaling algorithms, selects one of the scaling algorithms to scale image data such that quality of the scaled image is improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an image processing apparatus 1000 according to one embodiment of the present invention.

FIG. 2 is a flow chart of the scaling method of one embodiment of the present invention.

FIG. 3 illustrates examples of the image patterns of the present invention.

FIG. 4 illustrates the target pixel set according to the present invention.

FIG. 5 illustrates the background detector for detecting background information according to the invention.

FIG. 6 illustrates how to perform rectangular interpolation according to an embodiment of the present invention.

FIG. 7 illustrates how to perform triangular interpolation according to an embodiment of the present invention.

### DETAILED DESCRIPTION

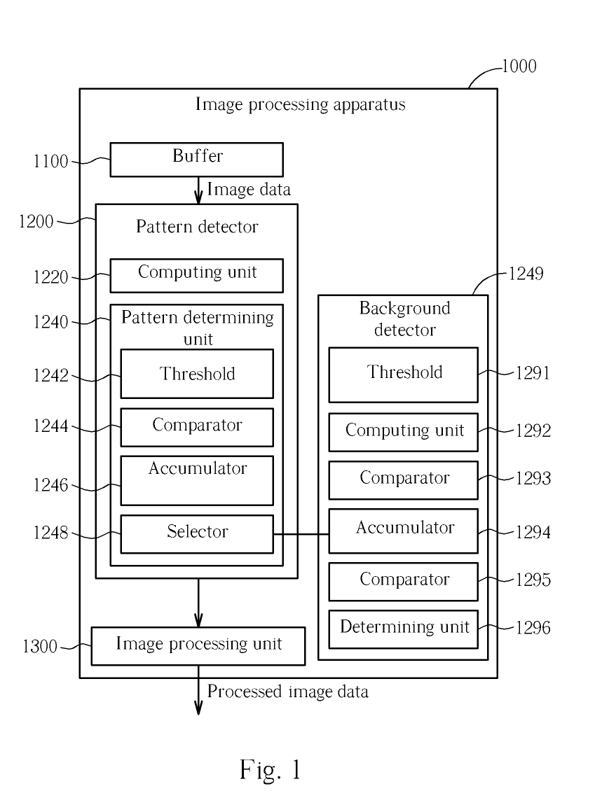

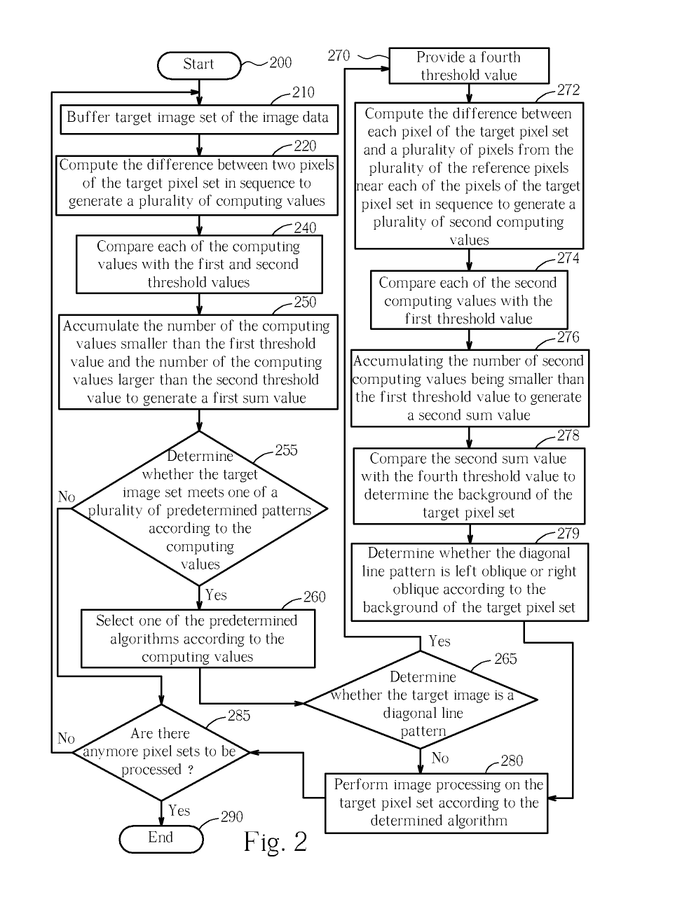

FIG. 1 illustrates an image processing apparatus 1000 according to an embodiment of the present invention. FIG. 2 is a flow chart of the scaling method of one embodiment of the present invention. The apparatus 1000 scales-up or scales-down image data. The apparatus 1000 includes a buffer 1100, a pattern detector 1200 and an image processing unit 1300. The buffer 1100 is used for buffering target image set of the image data (Step 210 in FIG. 2). The pattern detector 1200 detects if the target pixel set corresponds to one of the plurality of predetermined patterns. The apparatus 100 further includes a background detector 1249 for determining a background information of the target pixel set. In one embodiment, the predetermined patterns are corresponding to at least two image processing algorithms. The image processing unit 1300 performs image processing on the target pixel set according to the corresponding processing algorithm. In one embodiment, the processing algorithm is a scaling algorithm.

As shown in FIG. 1, the pattern detector 1200 includes a computing unit 1220 for computing the difference between two pixels of the target pixel set in sequence to generate a plurality of computing values (Step 220 in FIG. 2), and a pattern determining unit 1240 determines if the target pixel set corresponds to the pattern according to the computing values. In one embodiment, the pattern determining unit 1240 comprises a threshold 1242, a comparator 1244, an accumulator 1246, and a selector 1248. In the preferred embodiment, the threshold 1242 provides first, second, and third threshold values. The comparator 1244 compares each of the computing values with the first and second threshold values (Step 240 in FIG. 2). The accumulator 1246 accumulates the number of the computing values smaller than the first threshold value and the number of the computing values larger than the second threshold value to generate a first sum value (Step 250 in FIG. 2). If the first sum value is smaller than the third threshold value (Step 255 in FIG. 2), the selector 1248 informs the image processing unit 1300 and the image processing unit 1300 performs image processing on the target pixel set according to a preset algorithm. If the first sum value reaches the third threshold value (Step 255 in FIG. 2), the selector 1248 selects one of the predetermined algorithms according to the computing values (Step 260 in FIG. 2), and the image processing unit 1300 performs image processing on the target pixel set according to the selected algorithm (Step 280 in FIG. 2).

Additionally, the selector 1248 can selects one of the predetermined algorithms according to the computing values and the background data from the background detector 1249. The background detector 1249 determines whether the diagonal line pattern is left oblique or right oblique by utilizing a plurality of the reference pixels nearby the target pixel set when the pattern selected by the selector 1248 is a diagonal line pattern (Step 285 in FIG. 2). In an embodiment, the background detector 1249 comprises: a threshold 1291, computing unit 1292, comparators 1293, 1295, an accumulator 1294, and a determining unit 1296. In this embodiment, the threshold 1291 provides a fourth threshold value (Step 270 in FIG. 2). The computing unit 1292 computes the difference between each pixel of the target pixel set and a plurality of pixels from the plurality of the reference pixels near each of the pixels of the target pixel set in sequence to generate a plurality of second computing values (Step 272 in FIG. 2). The comparator 1293 is compares each of the second computing values with the first threshold value (Step 274 in FIG. 2). The accumulator 1294 is used for accumulating the number of second computing values being smaller than the first threshold value to generate a second sum value (Step 276 in FIG. 2). The comparator 1295 compares the second sum value with the fourth threshold value to determine the background of the target pixel set (Step 278 in FIG. 2). The determining unit 1296 determines whether the diagonal line pattern is left oblique or right oblique according to the background of the target pixel set (Step 279 in FIG. 2). The image processing unit 1300 performs image processing on the target pixel set according to the determined algorithm (Step 280 in FIG. 2).

It should be noted that the above-mentioned elements and operations are only for example and are not intended to limit the scope of the present invention. Additionally, the threshold values can be adjusted.

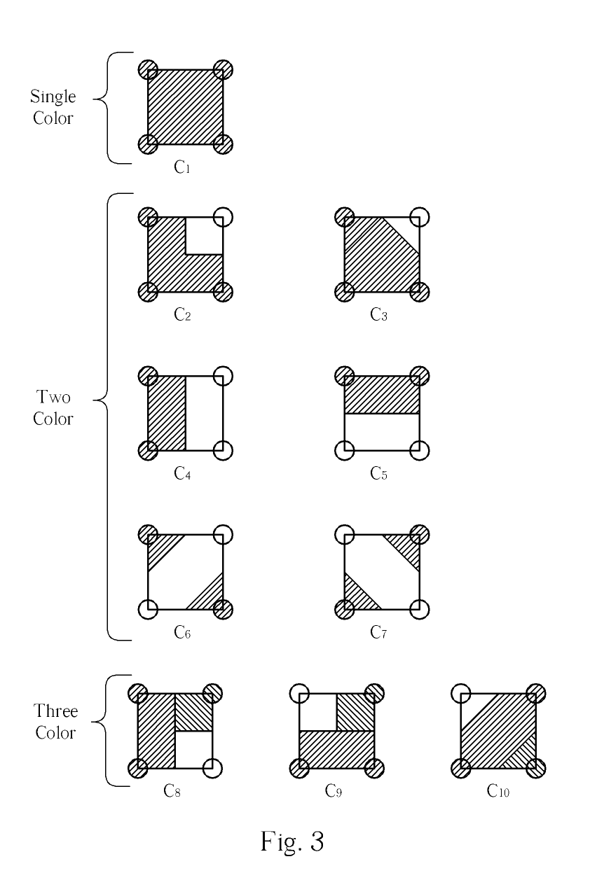

FIG. 3 illustrates examples of an embodiment of the predetermined patterns of the present invention. In the embodiment, the number of colors (or patterns) that each of the four pixels jointly possess classifies the predetermined patterns. As shown in FIG. 3, the three kinds include single color, two colors, and three colors. Single color means that the four pixels have patterns with the same color. Two colors can be three pixels having the same patterns (C2, C3), or two pixels with the same patterns (C4, C5, C6, C7). Three colors can be two pixels with the same pattern, and two with different patterns (C8, C9, C10).

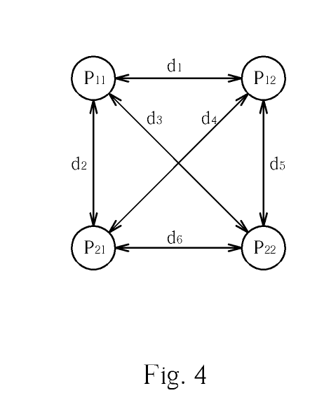

FIG. 4 illustrates an embodiment of the target pixel set of the present invention. In the embodiment, the target pixel set is a 2×2 matrix with four pixels P₁₁, P₁₂, P₂₁ and P₂₂. The computing unit 1220 computes the absolute value from 6 sets of difference values (i.e. (P₁₁, P₁₂), (P₁₁, P₂₁), (P₁₁, P₂₂), (P₁₂, P₂₁), (P₁₂, P₂₂), (P₂₁, P₂₂)) to obtain a plurality of computing results d₁, d₂, d₃, d₄, d₅ and d₆. Afterwards, the comparator 1244 compares the computing result d₁ with a first threshold value t₁ and a second threshold value t₂. Pixels P₁₁ and P₁₂ are supposed to have the same color when the computing result d₁ is smaller than the first threshold value t₁. Also, pixels P₁₁ and P₁₂ are supposed to have different colors if the computing result d₁ is larger than the second threshold value t₂. However, pixels P₁₁ and P₁₂ cannot be determined that they have the same color or not if the computing result d₁ falls between the first threshold value t₁ and the second threshold value t₂. Other pixel sets (P₁₁, P₂₁), (P₁₁, P₂₂), (P₁₂, P₂₁), (P₁₂, P₂₂), (P₂₁, P₂₂) follow the same rule. Afterwards, the selector 1248 selects a corresponding pattern from the predetermined patterns as shown in FIG. 3 according to the detecting results from the comparator 1244. It should be noted that the pattern corresponding to the target pattern set is a diagonal line pattern (C₆, C₇) if pixels P₁ and P₂₂ have the same color, and pixels P₁₂ and P₂₁ have the same color. The selector 1248 needs background information of the target pixel set to determine whether the diagonal line pattern is a left oblique pattern (C₆) or a right oblique pattern (C₇). Therefore, the background detector 1249 is used for detecting the background information of the target pixel set.

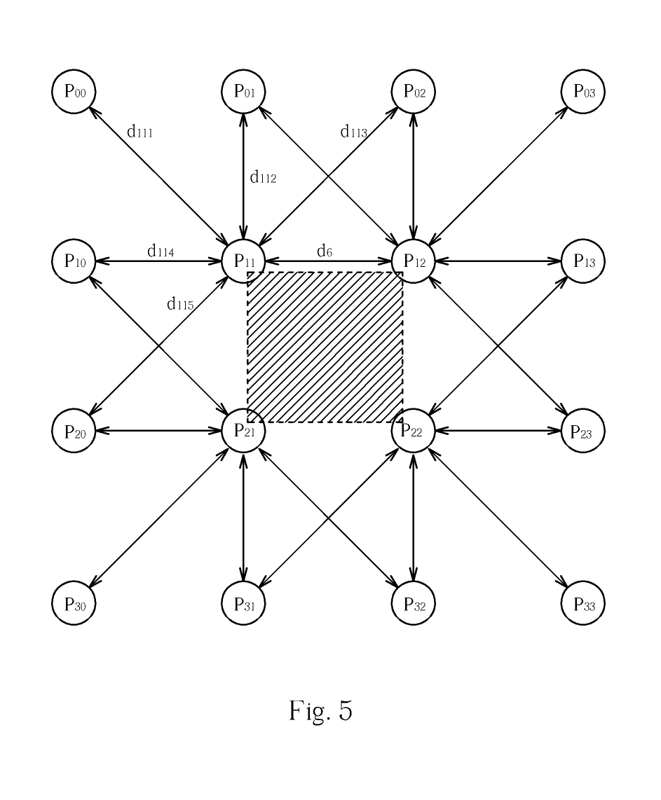

Please refer to FIG. 5, the computing unit 1292 of the background detector 1249 computes the difference between four pixels P₁₁, P₁₂, P₂₁ and P₂₂ and a plurality of pixels nearby. Take the process of P₁₁ for example, the absolute value of differences between P₁₁ and P₀₀, P₁₁ and P₀₁, P₁₁ and P₀₂, P₁₁ and P₁₀, P₁₁ and P₂₀ are computed respectively to obtain a plurality of computing results d₁₁₁, d₁₁₂, d₁₁₃, d₁₁₄, and d₁₁₅. After that, the comparator 1293 compares the computing result d₁₁₁ and the first threshold value t₁, and regards pixels P₁₁ and P₀₀ as having the same color if the computing result d₁₁₁ is smaller than the first threshold value t₁. Other pixel sets P₁₁ and P₀₁, P₁₁ and P₀₂, P₁₁ and P₁₀, P₁₁ and P₂₀ also follow the same rules. Thus each of four pixels P₁₁, P₁₂, P₂₁ and P₂₂ has five corresponding computing results.

Operation of one of embodiments of background detection is shown below:

If the selector 1248 determines that the four pixels P₁₁, P₁₂, P₂₁ and P₂₂ are patterns with the same color (that is, pattern C₁ in FIG. 3), the accumulator 1294 accumulates the number of the pixels near pixels P₁₁, P₁₂, P₂₁ and P₂₂ to obtain a sum value S₁. Next, the comparator 1295 compares the sum value S₁ and the fourth threshold value t₄ and the background color is regarded as the same as P₂₂ if the sum value S₁ is larger than the forth threshold value t₄.

If the selector 1248 determines that the three pixels P₁₁, P₁₂, and P₂₁ are patterns with the same color (that is, patterns C₂ and C₃ in FIG. 3), the accumulator 1294 accumulates the number of the pixels near pixels P₁₁, P₁₂, and P₂₁ with the same color to obtain a sum value S₂. Next, the background color is regarded as the same as P₁₂ if the sum value S₂ is larger than the forth threshold value t₄.

According to yet another embodiment, if the selector 1248 determines two pixels P₁₁, and P₂₁ are patterns with the same first color and two pixels P₁₂, and P₂₂ are patterns with the same second color (that is, the pattern C₄ shown in FIG. 3), the accumulator 1294 accumulates the number of the pixels near pixels P₁₁ and P₂₁ with the same color to obtain a sum value S₃, and accumulates the number of the pixels near pixels P₁₂ and P₂₂ with the same color to obtain a sum value S₄. Next, the comparator 1295 compares the sum values S₃ and S₄ with the fourth threshold value t₄ respectively. The background color is regarded as the same as P₁₁ if the sum value S₃ is larger than the sum value S₄ and the forth threshold value t₄, and the background color is regarded as the same as P₁₂ if the sum value S₄ is larger than the sum value S₃ and the forth threshold value t₄.

As the two pixels P₁₁ and P₂₂ are patterns with the same first color, the two pixels P₁₂ and P₂₁ are patterns with the same second color (that is, patterns C₆ and C₇ shown in FIG. 3), the above-mentioned background detecting operation can determine the background color. The determining unit 1296 determines the diagonal line pattern is a left oblique pattern (C6) if the background color is supposed to have the same color as P₁₁, and the determining unit 1296 determines the diagonal line pattern is a right diagonal pattern (C7) if the background color is supposed to have the same color as P₁₂.

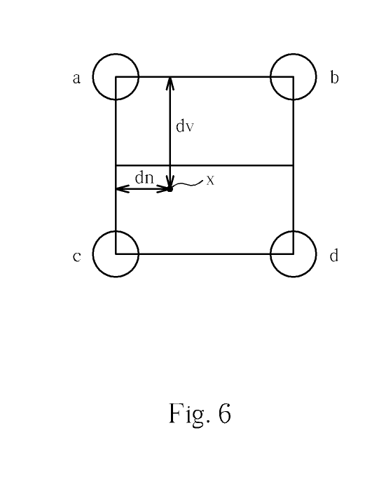

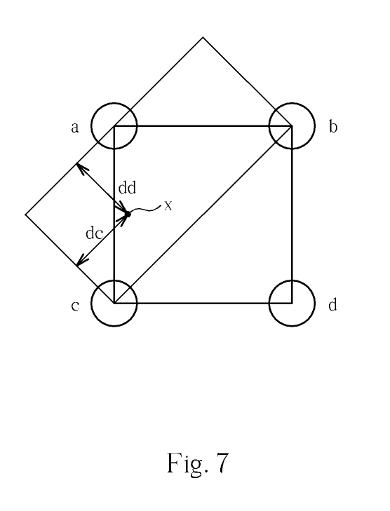

FIG. 6 illustrates how to perform rectangular interpolation according to an embodiment of the present invention. FIG. 7 illustrates how to perform triangular interpolation according to an embodiment of the present invention. As shown in FIG. 6, the rectangular-interpolation method is utilized if the corresponding pattern is horizontal or vertical (for example, patterns C₂, C₄, and C₅ shown in FIG. 3). The pixel x are computed according to the distances dv and dh between four target pixels (a, b, c, d), wherein the distances dv and dh are used as weighting factors and f(x) is a linear interpolation function. The formula is shown as below:

a×f(dh)×f(dv)+b×f(1−f(dh))×f(dv)+c×f(dh)×(1−f(dv))+d×(1−f(dh))×(1−f(dv))

If the corresponding pattern is a diagonal line pattern (for example, the patterns C₆, C₇, C₁₀), the triangular-interpolation method is utilized. This copying two pixels a1 and a2, which correspond to pixel b, c respectively, and the pixel b, c form a rectangle (a1, a2, b, and c). The pixel x is computed according to the distances dc and dd between four pixels (a1, a2, b, and c), wherein the distances dc and dd are used as weighting factors and f(x) is a linear interpolation function. The formula is shown as below:

a'f(dd)+ff(bc)×(1−f(dd))

ff(bc)=c×f(dc)+b×(1−f(dc))

It should be noted that the linear interpolation function f(x) is only an example, as other interpolation methods, such as two order or three order interpolation methods also fall within the scope of the present invention. Furthermore, the size of a matrix of pixel sets is not limited to 2×2, as an arbitrary M×N matrix of pixel sets can also be used.

Those skilled in the art will readily observe that numerous modifications and alterations of the device and method may be made while retaining the teachings of the invention.

What is claimed is:

1. A method for processing image data having a plurality of pixels, the method comprising:
buffering at least one portion of the pixels of the image data;
determining whether a target pixel set of the image data corresponds to one of a plurality of predetermined patterns, wherein the predetermined patterns correspond to at least two processing algorithms; and
processing the target pixel set according to one of the at least two processing algorithms when the target pixel set corresponds to one of the predetermined patterns.

2. The method of claim 1, wherein the step of determining comprises:
computing the difference between two pixels of the target pixel set to generate a plurality of first computing values; and
selecting one of the predetermined patterns according to the first computing values and at least one threshold value.

3. The method of claim 2, wherein the at least one threshold value comprises first and second threshold values, wherein the step of determining further comprises:
comparing each of the first computing values with the first and second threshold values;
accumulating the number of first computing values being smaller than the first threshold value, and the number of first computing values being larger than the second threshold value to generate a first sum value; and
selecting one of the predetermined patterns according to the computing values when the first sum value reaches the third threshold value.

4. The method of claim 3, wherein the step of selecting comprises:
determining whether the diagonal line pattern is left oblique or right oblique according to the computing values and a background information of the target pixel set when the predetermined pattern is a diagonal line pattern.

5. The method of claim 4 further comprises:
detecting the difference between each pixel of the target pixel set and a plurality of reference pixels near each from the pixel of the target pixel set to generate a plurality of second computing values;
determining the background information of the target pixel set according to the second computing values and the target pixel set.

6. The method of claim 1, further comprising:
determining a background information of the target pixel set;
wherein the target pixel set of the image data corresponds to one of a plurality of predetermined patterns according to the computing values and the background information of the target pixel set.

7. The method of claim 1, wherein the at least two processing algorithms are scaling algorithms.

8. An apparatus for processing image data having a plurality of pixels, comprising:
a buffer, for buffering at least one portion of the pixels of the image data;
a pattern detector, coupled to the buffer, configured to determine whether a target pixel set of the image data corresponds to one of a plurality of predetermined patterns, wherein the predetermined patterns correspond to at least two processing algorithms; and
an image processing unit, coupled to the detecting unit, configured to process the target pixel set according to one of the at least two processing algorithms when the target pixel set corresponds to one of the predetermined patterns.

9. The apparatus of claim 8, wherein the pattern detector comprises:
a first computing unit, for computing the difference between two pixels of the target pixel set to generate a plurality of first computing values; and
a pattern determining unit, coupled to the comparing unit, to select one of the predetermined patterns according to the computing values and at least one threshold value.

10. The apparatus of claim 9, wherein the at least one threshold value comprises first and second threshold values, wherein the pattern determining unit comprises:
a comparing unit for comparing each of the first computing values with the first and second threshold values;
a accumulating unit for accumulating the number of first computing values being smaller than the first threshold value, and the number of the first computing values being larger than the second threshold value to generate a first sum value; and
a selector for selecting one of the predetermined patterns according to the computing values when the first sum value reaches the third threshold value.

11. The apparatus of claim 10, further comprises:
determining a background information of the target pixel set;
wherein the target pixel set of the image data corresponds to one of a plurality of predetermined patterns according to the computing values and the background information of the target pixel set.

12. The apparatus of claim 8, wherein the at least two processing algorithms comprises a rectangular interpolation algorithm and a triangular interpolation algorithm.

13. The apparatus of claim 8, further comprises:
a background detector configured to determine a background information of the target pixel set;
wherein the target pixel set of the image data corresponds to one of a plurality of predetermined patterns according to the computing values and the background information of the target pixel set.

14. The apparatus of claim 13, wherein the at least two processing algorithms are scaling algorithms.

15. The apparatus of claim 8, wherein the at least two processing algorithms are scaling algorithms.

16. An apparatus for processing image data having a plurality of pixels, comprising:
a buffer for buffering at least one portion of the pixels of the image data;
a background detector configured to determine a background information of the target pixel set;
a pattern detector, coupled to the buffer, configured to determine whether a target pixel set of the image data corresponds to one of a plurality of predetermined patterns according to the background information of the target pixel set, wherein the predetermined patterns correspond to at least two processing algorithms; and
an image processing unit, coupled to the pattern detector, configured to process the target pixel set according to one of the at least two processing algorithms when the target pixel set corresponds to one of the predetermined patterns.

17. The apparatus of claim 16, wherein the at least two processing algorithms are scaling algorithms.
